(19) United States
(12) Patent Application Publication
(10) Pub. No.: US 2005/0007898 A1
(43) Pub. Date: Jan. 13, 2005

(54) Large capacity high speed read/write optical disk system

(76) Inventor: Takeshi Maeda, Koganei (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/864,639

(22) Filed: Jun. 10, 2004

(30) Foreign Application Priority Data
Jul. 11, 2003 (JP) 2003-195452

(51) Int. Cl. G11B 7/085

(52) U.S. Cl. 369/30.38

(57) ABSTRACT

Library system having a structure with improved response. A library for storing multiple optical information media, and a unit installed with a read/write drive for storing multiple optical record media, and the optical record media inside the cassette in the unit is conveyed to the read/write drive, in which a plurality of units are installed in the library system, and the system contain a conveyance means between the library and the unit to convey optical record media stored in the library to the cassette inside the unit.

### CLAIM OF PRIORITY

The present invention claims priority from Japanese application JP 2003-195452 filed on Jul. 11, 2003, the content of which is hereby incorporated by reference into this application.

### FIELD OF THE INVENTION

The present invention relates to a system for reading and writing information on a medium utilizing changing optical characteristics, and relates in particular to a large capacity, high-speed optical disk system.

### BACKGROUND OF THE INVENTION

Electronic libraries and other computer systems use large capacity, high performance library array devices for holding their recording medium. These library array devices each contain a medium loader entry (hereafter called mass entry) for loading the recording medium from an external section of the device to an internal section, or from an internal section of the device to an external section; and a storage box (also called a magazine) for storing large numbers of freely insertable/removable portable disk recording disks (for example CD or DVD, etc.); and at least one drive (for example, disk drives) for reading and or writing data on a specified disk; and a carrier to convey the disk between the mass entry, storage box and drive. Multiple library device units with identical structures are redundantly connected together to comprise a redundant array. One example in particular using this type of device is known in the related art as RAIL (Redundant Arrays of Inexpensive Libraries). In this RAIL device, multiple library units are simultaneously operated in parallel to achieve a disk library array device capable of subdividing and writing the desired data on respective disks or reading (loading) the subdivided data at high speed. In disk library array devices of this type capable of reading or writing multiple storage mediums in parallel, the multiple storage mediums (disks) for parallel processing must be managed as one volume set (called a RAID {Redundant Array of Inexpensive Disks} group).

Conventional disk library array devices are designed to load and unload (eject) storage cartridges capable of holding multiple storage medium elements, for example, CD or DVD from the mass entry of each library unit. These disk library array devices can also consecutively load and unload, these multiple storage medium pieces belonging to different RAID groups, from each library unit. However integrated management of multiple recording medium elements such as CD or DVD belonging to the same RAID group is difficult because; storage medium from different RAID groups are mixed together in the (same) storage cartridge, and multiple storage medium from the same RAID group are stored in multiple different storage cartridges. Therefore the following library device is proposed.

Namely, a method was disclosed (JP-A No. 325075/2001) as shown in FIG. 1, for library array device capable of batch processing by storing multiple storage medium elements belonging to the same RAID, into one storage cartridge by storing all recording medium elements of the same RAID group into the same storage cartridge, and loading/unloading storage medium elements from one storage cartridge into multiple library units. The library array device must also ensure conformance (compliance) during loading/unloading the storage medium (disk) between the storage cartridge and library units. In other words, to provide a library array device that continuously ensures that only storage medium belonging to the same RAID group are stored in one cartridge, by constantly checking that all storage medium stored in the cartridge belong to the same RAID group during loading/unloading.

FIG. 1 is a perspective view showing the overall structure of an embodiment of the library array device of the related art. FIG. 2 is a perspective view showing the overall structure of an embodiment of the library unit U for the library array device shown in FIG. 1. This figure shows the overall structure of a library array device containing six library unit U units all having an identical structure. In the following description, the term “disk” (storage medium) does not refer merely to a disk but also may include the meaning of a tray housing the disk. In the library array device of the related art, the different types of control orders such as data read/write commands are issued from an upper (upstream) control device such as a personal computer (not shown in drawing) or a panel P installed on the operator side, to the array controller A by way of a controller interface (not shown in drawing) such as an SCSI interface, to operate the six library units U (hereafter referred to simply as units) in parallel to read and write data on the disk at high speed. In other words, the array controller A is made up of a microcomputer comprised of MPU, ROM, or RAM (not shown in drawing) . The array controller A conveys a disk to each unit U in compliance with the control order that was issued, and operates the drives 10 and 11 of each unit U for reading and writing data.

Cartridges can be loaded and unloaded on the operator side of unit U to the mass entry M as shown in the drawing. The cartridge feed unit CM also contains a read-out (scanning) means for reading the cartridge CI identification information (described later) written at a specified position on the cartridge C. The multiple units U, array controller A and the cartridge feed unit CM are generally all installed within one cabinet (body) and all comprise one library array device. The cartridge feed unit CM is in this way configured to cross each specified position on unit U. One cartridge loading slot IO is formed in the cartridge feed unit CM to allow loading and unloading the cartridge C. In other words, in the present embodiment, the cartridge feed unit CM is configured to move the loaded cartridge C from the cartridge loading slot IO along the direction of the X arrow, shift the cartridge C laterally (direction of Y arrow) and stop the cartridge C at sequential positions relative to the mass entry M (described later) of each unit U. The cartridge feed unit CM more specifically contains a mechanism to move the cartridge C laterally (direction of Y arrow); and a mechanism to load and unload the cartridge C in the mass entry M. The cartridge C can in this way be loaded and unloaded (inserted and extracted) in the mass entry M of each unit U. Each cartridge feed unit CM contains a scanning means to read-out the cartridge identification information CI (described later) listed at the specified position on the cartridge C. One library array device is generally comprised of multiple units U, the array controller A, and the cartridge feed unit CM are all installed within one cabinet (or body)

As shown in FIG. 2, when the unit U receives a data read/write order from the array controller A, the desired disk is extracted from the many storage cabinets Ta (only one is shown in the drawing for the purposes of simplification) of storage container T storing the disks. The unit U operates a feed holder H to mount the extracted disk into one of any one of the multiple drives 10 through 11 (two drives in this embodiment). The unit U then reads or writes data on the disk by operating the drives 10 through 11 holding that disk. Each unit U in other words is configured to operate as a single unit to read or write data on the disk. Each unit U can also read or write different data on multiple RAID group units by operating the multiple drives 10 through 11 (of unit U) in parallel. A mass entry M is installed in each unit U. The mass entry M loads disks from outside the library array device into the unit U. The mass entry M also unloads (or ejects) disks from inside the unit U to outside the library array device. In the present embodiment, the mass entry M is formed in a shape allowing loading and unloading the multiple disks of each cartridge C. In other words, the cartridges C are fed sequentially to each unit U by way of the cartridge feed unit CM, are loading in the mass entry M of a unit U. The unit U feeds one among the multiple disks stored inside the cartridge C loaded in the mass entry M by the feed holder H, to the drives 10 through 11. After completing the cartridge loading (or unloading), the unit U feeds the disk to the storage container T and stores the disk (described in detail later).

[Patent document 1] JP-A No. 325075/2001

[Non-patent document] D. A. Ford, R. J. T. Morris and A. E. Bell, “Redundant Arrays of Inexpensive Libraries (RAIL): A Tertiary Storage System, “Proceedings of COMPCON '96, pp. 280-285, 1996.

This disk library array proposed in the related art was sufficient for managing and storing all storage medium (disks) belonging to the same RAID group into one cartridge. However further changes to the structure were needed in order to improve the performance of the disk library.

The optical disk library device of the related art had the object of increasing user data handling capacity per each cartridge by increasing the data capacity per single disk by n number of times by operating n number of RAID drive units by parallel data transfer. The library device of the related art accomplished this object by increasing the transfer speed per one library unit by n times and further by storing and managing n number of disks in each one cartridge. However, though the device of the related art had good data transfer speed and good data capacity, it had the problem of a slow response during data accessing from the user. The delayed response in particular to large amounts of sequential data equivalent to multiple cartridges had the effect of restricting library applications.

### SUMMARY OF THE INVENTION

To resolve these problems, the present invention therefore proposes a library system possessing a structure with improved response.

To resolve the aforementioned problems with the device of the related art, the library system of the present invention comprises: a library for storing multiple optical information medium, a cassette for storing the multiple optical recording medium and a unit installed with a read/write drive, wherein the optical recording medium in the cassette within the unit is conveyed to the read/write drive; wherein a plurality of units are provided, and contain a conveyance means installed between the library and the unit, for conveying the multiple optical recording medium stored in the library, to the cassette inside the unit.

To improve the response to data access from the user, the present invention shortens the time required for simultaneous loading and unloading of the multiple medium belonging to the same RAID group, from the medium cabinet into the multiple drive units. To shorten this time the present invention contains two means for conveyance from the medium cabinet to the drive device. First of all, the medium is extracted one disk at a time from the medium cabinet by one feed means and mounted in a cassette storing multiple medium (disks) and forming a unit with the read/write device. In other words, the storage medium (disks) stored in the cartridges are extracted one disk at a time on each feed tray, the feed tray clamped on a media carrier, and fed to the cassette insertion slot on the unit and inserted there. Among the multiple medium loaded in the cassette within the unit, those medium belonging to the same RAID group as medium stored in other units, are selected based on the numbering described below and loaded from the cassette into the read/write device by another feed means.

The numbering for selecting the medium is described next while referring to FIG. 9. The cartridge identification information CI on the cartridge C is recorded (in this embodiment, the specified position is the position where the scanning means installed on the cartridge feed unit CM side can scan {or read-out} the cartridge identification information CI) at the specified position. The cartridge identification information CI is information for identifying the RAID group. This cartridge identification information CI contains different respective information on RAID groups. In the example given in this embodiment, the cartridge identification information CI is affixed to the upper surface of the cartridge C as a barcode however the invention is not limited to this method. Disk control information on the other hand, is recorded in the information recording area on the disk D. This disk control information is grouped into cartridge identification information DC and disk identification information DI. This cartridge identification information DC is information for deciding what RAID group that the disk D belongs to. Different information is recorded in RAID group units on the cartridge information DC. In other words, if the RAID group is the same, then that same information is recorded on both the cartridge identification information DC, and on the cartridge identification information CI affixed to that cartridge C. The disk identification information DI is information for identifying the multiple disks D belonging to the same RAID group. The disk identification information DI is recorded with different information on each RAID group. For example, a barcode expressing the cartridge identification information CI as “A” is recorded in a specified position on the cartridge C holding six disks D belonging to the RAID group called “Data A”. Also, each disk D stored in the cartridge C is recorded with an, “A-1” “A-2” . . . “A-6” as disk control information (In other words, “A” is recorded as the particular cartridge identification information DC and “1” through “6” are recorded as the disk control information DI).

In this structure, the distance to convey the multiple medium (disk) from the cabinet becomes longer as the capacity increases and time is also required. However the distance from the cassette to the read/write device within the unit is short so that the conveyance time within the cassette can be shortened. In this structure, if the RAID group for read/write is already known, then the disk conveyance time can be shortened by conveying, the disks belonging to that group ahead of time, one by one to the respective cassette. By further using data management called look-ahead and look-back, then not only disks belonging to that RAID group but other disks belonging to prior and latter groups can be placed within a cassette to drastically improve the response as seen by the user.

The operation flow up to the disk loading is next shown in detail in FIG. 10. The drive for m units uses synchronized transfer with the technology of the related art. The present invention contains m units. The technology of the related art and the present invention are compared with a structure where each unit changer incorporates a structure capable of storing M disks. The flow in the technology of the related art is shown in FIG. 10A. In the technology used in the related art, an instruction first arrives to load the data of RAID group N. The unit searches the cabinet for RAID group N cartridges, extracts the disks one at a time, and conveys them to the m unit drive. In this structure, the time required for extracting disks from the cartridge and conveying them to the m units takes approximately m times as much time as the conveyance time T1 for one unit. This time is required because the movement distance is long due to the cabinet storage capacity and the fact the one conveyance means moves one disk at a time. If the time from the start of loading of each drive and read-out (write) is set as T2, then a time of T1×m+T2 is required from the receiving the read-out (write) order to the start of synchronized transfer.

However as shown in the flow chart of FIG. 10B of the present invention, each disk belonging to the M RAID group is stored ahead of time, as M number of disks each, in the changer within the m unit, prior to arrival of the order for scanning (recording) the RAID group N data. When the read-out (recording) order then arrives, the distance required to move the disk within the changer is small so the time T3 is short compared to the time T1. This disk belonging to that same RAID group is already within the changer so the (data) conveyance start time is T3+T2 and the response time up to read-out (recording) is therefore shortened.

### BRIEF DESCRIPTION OF THE DRAWINGS

FIG. 1 is a perspective view of the library array system of the related art;

FIG. 2 is a descriptive view of the library array of the overall structure of a single library unit;

FIG. 3 is a perspective illustrative view of the library device of the present invention;

FIG. 4 is a drawing for describing the disk magazine used in the present invention;

FIG. 5A is a drawing of the magazine and the disk tray mechanisms;

FIG. 5B is a drawing of the magazine and the disk tray mechanisms;

FIG. 5C is a drawing of the magazine and the disk tray mechanisms;

FIG. 6 is a drawing showing the storage medium mounted in the library unit of the present invention;

FIG. 7 is a drawing showing the storage medium mounted in the library unit of the present invention;

FIG. 8 is a block diagram of the optical disk drive;

FIG. 9 is a drawing showing the specified control information affixed to the disk; and

FIG. 10 is a flow chart showing the flow in the technology of the related art and the present invention;

### BRIEF DESCRIPTION OF THE PREFERRED EMBODIMENTS

The embodiments of the present invention are described next while referring to the drawings. In the following drawings, the same reference numerals are assigned to sections with the same functions.

FIG. 4 is a cross sectional view of the disk magazine used in the present invention. In other words, this drawing is a cross sectional view as seen from the side of a disk magazine 10 holding multiple optical disks 2. The disk magazine 10 as shown in this figure comprises a cylindrical disk case 1 and multiple optical disks 2 and a disk feed tray 3. Four optical disks are used in the description. A number of disk trays equaling the number of disks are used for conveying each optical disk. When using side A of the disk magazine as the upper surface as shown in this figure, the disk medium 2a positioned on uppermost level is mounted onto the disk feed tray 3a by its own weight. A disk setting bay 6 is installed on the upper surface of the disk feed tray 3a for more stable positioning of the disk medium 2a held in the disk feed tray 3a. The same configuration is used for the feed tray 3 and the disk mediums 2 on the second level, third level and lower-most level (of the disk magazine).

The optical disk medium 2 is utilized after being drawn into the optical disk changer. To draw in the optical disk medium 2, the optical disk medium 2 on the disk feed tray 3 engages with a pullout mechanism 36 inside the device and is conveyed inside. Though not shown in the drawing, a feed mechanism outside the device may be pressed inside (the optical disk changer). Reading and/or writing of information is then performed on the optical disk medium 2 drawn inside. When using side A of the disk magazine 10 as the upper side as shown in FIG. 4, the reading and writing of information is performed on the lower side of the disk which is the A side of the disk medium. To return the disk medium 2 into the disk magazine 10, the disk medium 2 is conveyed in the same way into the disk magazine 10 via the return path along with the disk feed tray 3.

When the B side of the disk magazine is the upper side, the double-sided tray such as 5b can also be used as the tray for disk 2b rather than just disk 2a.

In this structure, the tray can be extracted even when the disk magazine 10 is vertically inverted (disk magazine is inverted 180 degrees so side A of the disk magazine is the lower side). A disk setting bay 6 described above is formed in each disk feed tray 4 for positioning the disk medium. When using the A side of disk magazine 11 as the upper side, the optical disk medium 2a positioned on the uppermost level is loaded in the disk feed tray 4b. To use the optical disk medium 2a, it can be conveyed inside the unit along with the disk feed tray 4b. The A side of the optical disk medium 2a can be accessed in this way and reading/writing of information performed.

To use the other side or B side of optical disk medium 2a however, the disk magazine 11 is vertically inverted so that the B side of disk magazine 11 is the upper side. The optical disk medium 2a is in this way moved by its own weight on the disk feed tray 4a. To use the optical disk medium 2a at this time, it may be conveyed into the unit along with the disk feed tray 4a. The B side of the optical disk medium 2a can be accessed in this way. By rotating the disk magazine 11 insertion axis 180 degrees in this way, both sides of the optical disk medium 2a can be used for reading and writing information by switching the disk feed tray holding the optical disk medium 2a.

There are two disk feed trays 4 for each optical disk medium stored in this way. The disk feed trays 4c (for side B) and 4d (for side A) are used as feed trays for the optical disk medium 2b. The disk feed trays 4e (for B side) and 4f (for A side) are used as feed trays for optical disk medium 2c. The disk feed trays 4g (for B side) and 4f (for A side) are used as feed trays for the optical disk medium 2d. This structure in the disk magazine 205, with two optical disks 2 (N) and corresponding (N+1) disk feed trays 5 performs the following function. In this figure, four double-sided disks are used along with five disk feed trays. In this same figure, the disk setting bays 6 to hold the optical disk medium 2 were formed only on the double-sided disk feed trays 5b, 5c, 5d to receive the disks being conveyed. However, these disk setting bays 6 may be formed on five of the disk feed trays 5 to receive the optical disk changer and optical disk medium 2.

The description of the following embodiment uses the double-sided accessible disk magazine 12 shown in FIG. 4.

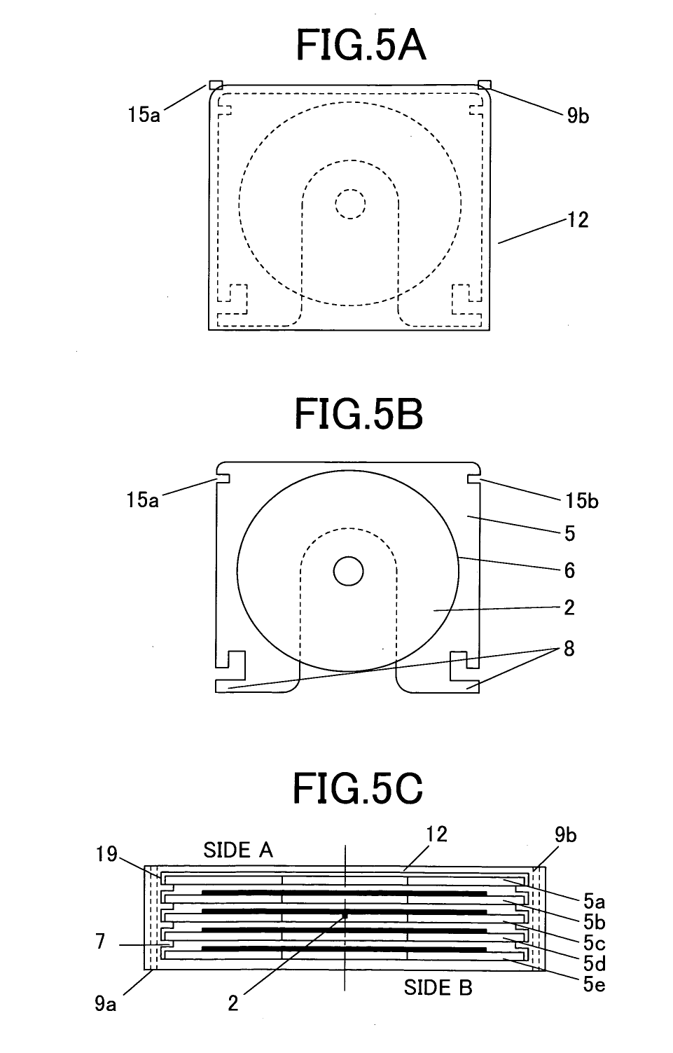

FIGS. 5A to 5C are drawings showing the disk magazine storing four optical disk medium 2. FIG. 5A is a transparent (see-thru) view as seen from the upper side (side A of the disk magazine). The disk magazine holds five disk feed trays 5. Each feed disk tray 5 is held by anti-flyout latches 9a, 9b as a structure to prevent the tray from releasing outwards easily.

FIG. 5B is a view from the upper side of the disk feed tray 5 and the optical disk medium 2 completely pulled out from the disk magazine 12. Among the five disk feed trays inside the disk magazine 12, three of the disk feed trays 5b, 5c, 5d contain a positioning groove 6 on both the front and rear sides for use when the disk is loaded. The disk trays 5a, 5e are each formed with a positioning groove 6 for holding the optical disk medium 2a, 2d on their inner sides. The disk feed tray 5 is held by an edge 7 described later, formed on the left and right inner sides of the disk case 1. An edge pitch is set so that a load is not applied during feed. When the disk feed tray 5 is pulled out of the disk magazine 12 and when returned to the disk magazine 12, the hooks 8 formed on the disk tray are made to engage with a pullout mechanism 36. This pullout mechanism 36 pulls in the entire disk feed tray and optical disk changer and pushes out the entire disk feed tray from the optical disk changer. These actions feed the optical disk medium 2 and the disk feed tray 5.

FIG. 5C shows the disk magazine 12 as seen from the insertion direction. The disk magazine 12 usually holding the disk feed tray 5 inside, contains tray anti-flyout latches 9 installed to prevent the tray from flying outwards unexpectedly during handling of the disk feed tray. In the present embodiment, these comb-shaped anti-flyout latches 9a, 9b are installed on the inner section of the magazine case. The stopper 13 for these anti-flyout latches are usually installed in the center position of the edge 7 pitch formed periodically on the inner side of the magazine case 1. These stoppers 13 make contact with the notches 15 shown in FIG. 5B and disable disk feed. In this case, the latch 9a, engages with the notch 15a, and the latch 9b engages with the notch 15b.

When the disk magazine 12 is loaded inside the unit, the mechanism in the unit presses up the comb-shaped anti-flyout latch 9a, and moves the stopper 13 up to a position in parallel with the edge 7. The disk feed tray can in this way move to the magazine external section.

As shown in FIG. 5C, the anti-flyout latches 9a, 9b are installed at symmetrical rotation positions, rotated 180 degrees centering around an axis parallel with the insertion direction across the center point Z of the disk magazine 12. As shown in FIG. 5B in the same way, the notches 15 are also installed at symmetrical rotation positions relative to the tray shape.

Therefore by using a rotationally symmetrical structure, the height of the disk feed tray 5 and the shape of the disk magazine 12 will not change even if rotated 180 degrees centered around the Z axis. The disk magazine 12 can be used while inverted upwards or downwards and therefore position information for accessing the disk feed trays 5 can be used in the same way even if the disk magazine is inverted upwards or downwards.

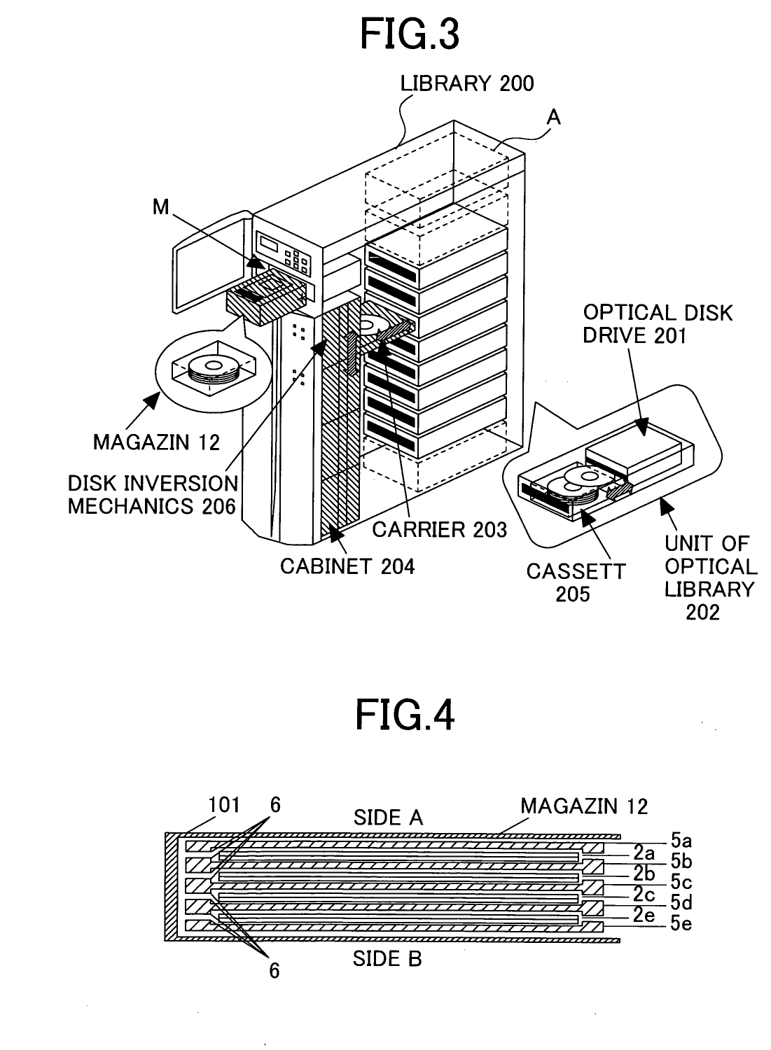

An embodiment of the library performing high speed read/write using this cartridge is described next while referring to FIG. 3. The disk magazine 12 described in FIG. 4 and FIGS. 5A to 5C is inserted into the library device 200 from the mass entry M, and is stored in the slot of the media cabinet 204 by the carrier 203. The entire disk magazine is inverted in a section of the media cabinet 204. A disk inversion mechanism 206 is installed when required. The entire magazine rotates in this section and is returned to the slot of the media cabinet 204 as needed. Even when the user wishes to retrieve data in RAID group units, the disk magazine is conveyed from the media cabinet to the mass entry M, extracted from that opening, and storage performed. This function is necessary because the data accumulated in a write-once type medium will at some point become full in the media cabinet. Also, both surfaces of the medium (disk) belonging to that RAID group can be utilized by rotating the entire magazine with the disk inversion mechanism.

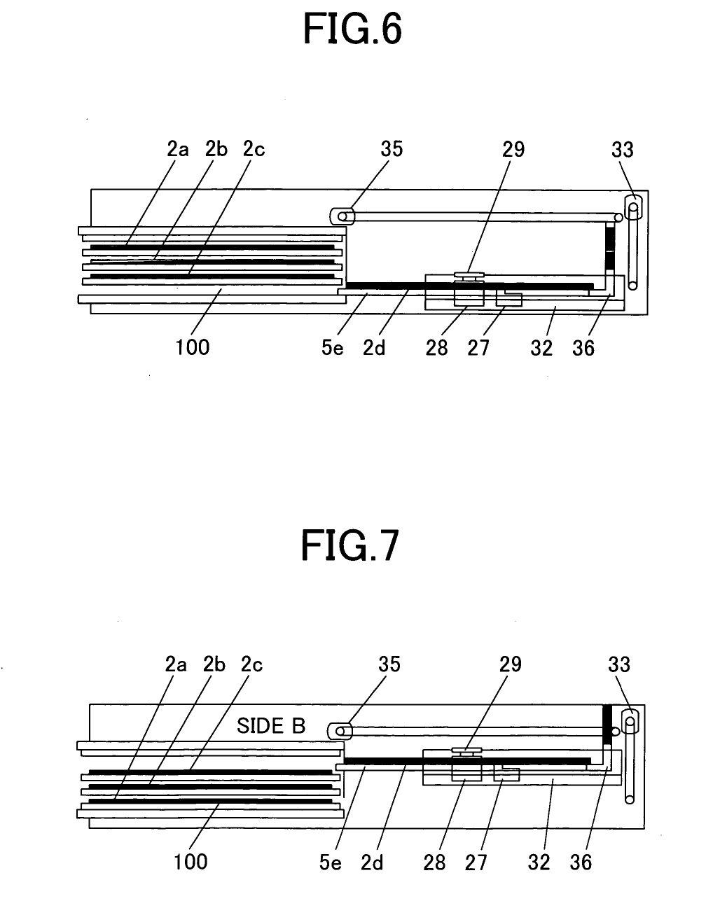

In other words, the disk magazine 100 can be loaded or unloaded from the optical disk library device while internally holding all the disk feed trays 5. The disk magazine can also be loaded in the optical disk library device while inverted upwards or downwards. To read/write on the B side, the entire disk magazine (or cassette) 100 is placed with the B side upwards by the inverter mechanism 206 and mounted in the slot of the optical disk library. On changing from side A to side B, the optical disk medium 2 moves to disk feed tray 5 positioned above the point where side A was mounted. The disk medium 2d moved to the disk feed tray 5d. At this time, the process when using side B of the disk medium 2d is the same as when using side A of the disk medium 2d and information reading and writing can be performed. Conversely, the same processing as during side A operation can be performed even when returning the optical disk medium 2d to inside the disk magazine 100. The disk cassette (or magazine) has 180 degree rotational symmetry as described above so that whichever surface (side) was installed, there is no actual change in the height of the feed tray. The disk feed tray 5e of FIG. 6 and the disk feed tray 5a of FIG. 7 for example have the same height. Therefore when there are four disks, then the height information sent from the main control device 21 to the height position controller 30 need only contain four pieces of information and the same value can be used whether using side A or side B.

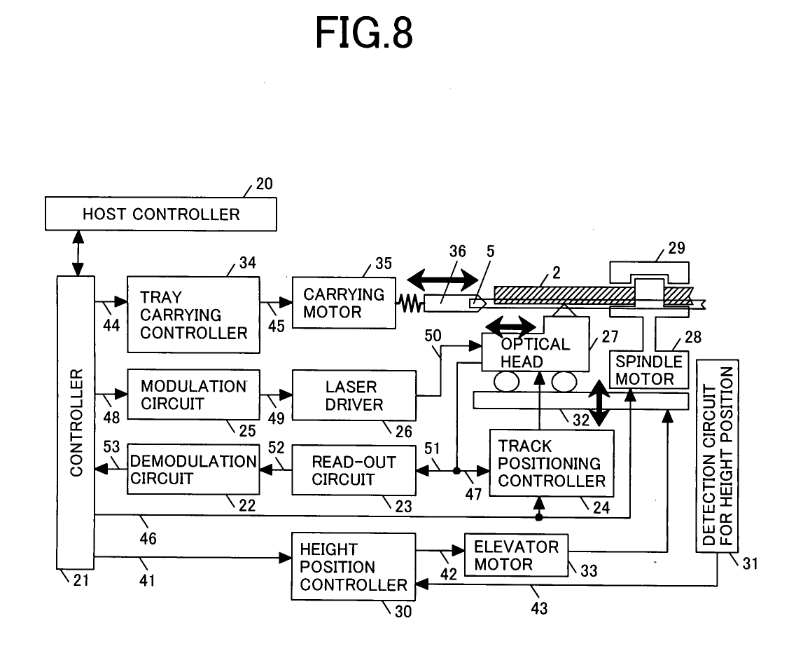

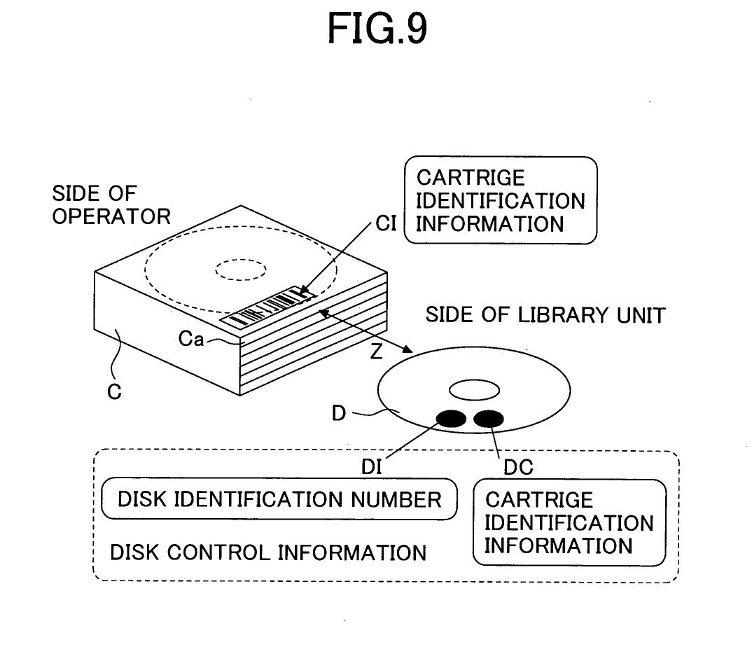

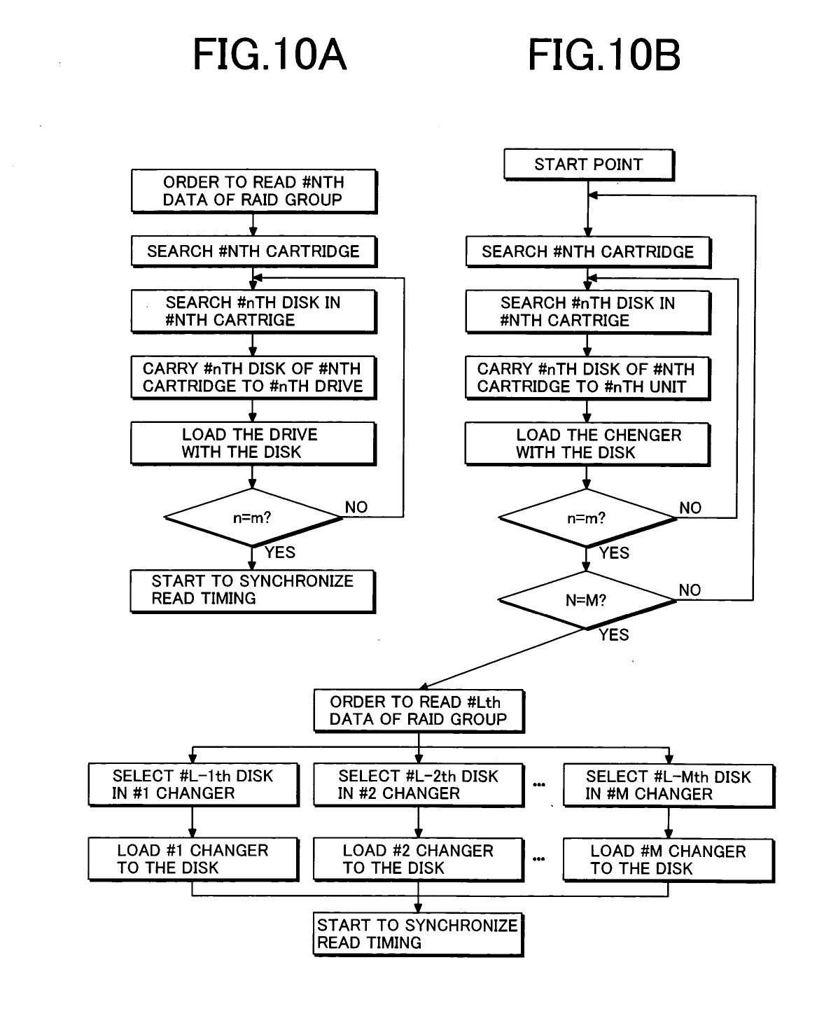

The medium for the RAID group inserted in the slot are extracted, (Operation of the extraction mechanism is described in detail later on using FIG. 6.) one each by the operation described in FIGS. 5A to 5C. A tray with a cassette 205 capable of holding multiple medium (disks) is inserted in one of the multiple units of optical library 202. The array controller A specifies a medium (disk) belonging to a group from the multiple medium held in the cassette 205 in the unit of optical library 202. That disk is then mounted on the spindle 29 and read/write performed by the operation (described later) shown in FIG. 6 and FIG. 8 by the optical disk drive 201 shown in the block diagram FIG. 8.

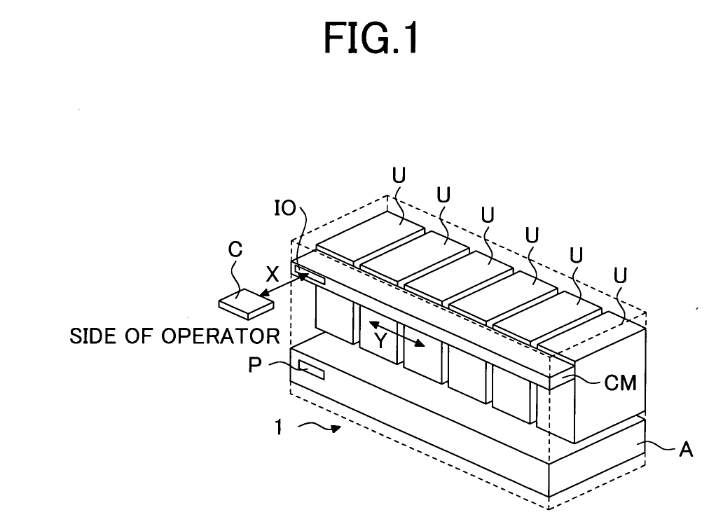

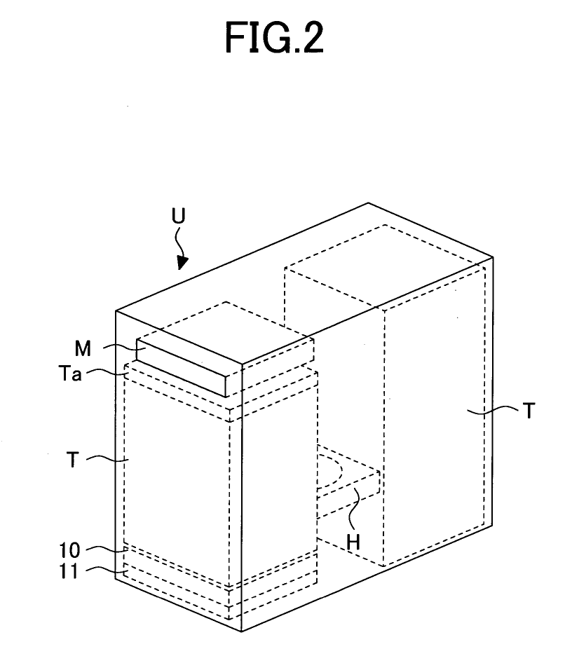

The disk medium belonging to that same RAID group is mounted into one of the multiple units of optical library 202. Simultaneous read/write of user data is performed controlled by the array controller A by the same operation as for the library U shown in FIG. 1 and FIG. 2 for the related art. This operation is the same as in the related art so a description is omitted here. The library capacity is on a small scale compared to the related art so RAID0 is more suitable as the RAID structure. The number of units will increase if using RAID 4 through 5 so even that structure may be used for a small scale library.

In the unit of optical library 202, the disk feed tray 5 is next extracted from the cassette 205 holding multiple optical disks 2. The embodiment of the unit of optical library 202 for reading and writing of information is next described using FIG. 8. The unit of optical library 202 in the same figure comprises: a spindle motor 28 to rotate the optical disk medium 2, an optical head 27 to read and write information on (from) the optical disk unit 2, a main control circuit 21 to control the overall system of the internal unit, a track positioning control system for the optical head 27 and functioning under the control of main control circuit 21, an information recording system, an information reading system, a tray pullout control system for performing disk feed, and a height position control system for moving the optical head 27 and the spindle motor 28 to adjust the height.

The selection of the desired disk medium specified by the host control circuit 20 from among the multiple disk medium 2, and the reading and writing of information are described next.

The height position control system is utilized to move the disk medium selected from the host control circuit 20. The desired disk height information 41 specified by the height position control controller 30 from the main control circuit 21 is sent, and converted into elevator electrical current (value) 42 within this same circuit, and sent to the elevator motor 33. The head base 32 moves up or down driven the elevator motor 33. Along with this movement, the movable parts such as the optical head 27 and spindle motor 28 attached to the head base 32 are moved up and down. The height position control obtains the current height information 43 by way of the detection circuit for height position 31 and continues driving the above components until this current height information matches the desired height information.

After the head base 32 is moved to the specified height position, the optical disk medium 2 to be used is pulled into the unit by the tray pullout control system. In order to pull out the specified disk feed tray 5, the main control circuit 21 issues an instruction 44 for pull-in to the tray carrying controller 34, and issues a drive signal 45 for the pull-in direction to drive the carrying motor 35 and move the pull-out mechanism 36 horizontally. The pull-out mechanism 36 catches on a feed pawl 8 at the tip of the specified disk feed tray 5 inside the disk cassette 205 and draws the feed tray (and disk) up to the center position of the spindle motor 28 inside the device.

The elevator motor 33 next drives the head base 32 slightly upward. The optical disk medium 2 is then raised by the disk changer device and the disk magazine spindle motor 28, and is suspended slightly above the disk tray 5. The optical disk medium 2 is clamped by the clamper 29 onto the spindle motor 28. The optical disk medium is later rotated up to a specified rotation speed by the spindle motor 28.

Positioning on the desired track is next implemented using the track positioning controller to position the optical head 27 at the track position specified by the host control circuit 20. The necessary position information 46 and the current position information 47 are at this time conveyed to the track positioning controller 24. The track positioning controller 24 drives the optical head 27 radially over the disk.

In the information write system, the write information 48 sent from the host control circuit 20 is converted into a written information code 49 via the modulation circuit 25. This written information code 49 is input to the laser driver 26, and becomes a drive current 50 according to the write pattern and sent to the optical head 27. The drive current 50 is then converted in the optical head 27, into optical intensity pulses by the semiconductor laser and laser driver not shown in the drawings. The optical intensity pulses are irradiated onto the surface of a recording film of the optical disk medium 2 and writing of information is performed.

In the information read system, a laser light is emitted at a scanning (read-out) power level. The laser light irradiates the recording film surface or the read-only film and reads the information. The read signal 51 from the optical head 27 is discriminated within the read-out circuit 23 and the (read) information code 52 obtained. Read information 53 is later obtained by demodulating the (read) information code 52 in the demodulation circuit. The read information is then sent via the main control device 21 to the host control circuit 20.

The main control device 21 is for example comprised of a central processing unit (CPU), a RAM for storing the CPU program, and a RAM for storing different types of data. These components are not shown in the drawing.

The embodiment of the unit of optical library 202 when loaded inside with multiple optical disk cassettes 205 is described next using FIG. 6. This figure illustrates the state when a disk cassette 205 capable of double-sided use is loaded with four optical disk medium 2, inside the optical disk unit. The internal operation at this time, using the case where the lower-most (lowest) disk medium 2d is installed at a position within the disk cassette 205 is described.

The elevator motor 33 is driven, and the optical head 27 and the spindle motor 28 held in the head base 32 within the optical disk changer are positioned at the height position of the disk feed tray 5e as described previously.

The (tray feed) carrying motor 35 afterwards drives the pullout mechanism 36 horizontally into the disk cassette and makes the tip of the disk feed tray 5e engage with the feed pawl 8. The (tray feed) carrying motor 35 is then driven in the reverse direction, to pull the disk feed tray 5e along with the disk medium 2d to the center position of the spindle motor 28.

The elevator motor 33 is then driven and drives the head base 32 slightly upwards. The spindle motor 28 raises the optical disk medium 2d. The optical disk medium 2d is placed slightly above the disk feed tray 5. The optical disk medium 2d is clamped to the spindle motor 28 by the damper 29. The optical disk medium 2d is raised slightly above the disk feed tray 5 to prevent the optical disk medium 2d and the tray from making contact with each other.

The optical head 27 is then positioned at the specified track position based on information from the host control circuit 20 and writing and reading of information performed as described above.

Conversely, to return the optical disk medium 2d to inside the disk cassette 205, the driving of the spindle motor 28 is stopped and the disk rotation stopped. The damper 29 is then released, the head base moved slightly downwards and the optical disk medium 2d placed on the disk feed tray 5e. In this state, the (tray feed) carrying motor 35 is driven, and the disk feed tray 5e held in the tray pullout mechanism 36 is stored in the disk cassette 205.

The embodiment utilized an optical disk as the information (record) media. However the present invention is not limited to this media, and may be implemented with a magnetic disk medium possessing an information surface on both sides or a flexible disk medium, etc. The optical disk medium is a general name including read-only optical disk medium, write-once optical disk medium, magneto-optical disk medium, phase-change information medium, and dye information medium.

The optical disk device of the above embodiments contained both a write function and a read function, however the device may contain either or both of these functions.

The present invention provides a high-speed, large capacity optical disk library system also having improved response for reading and writing.

1. A library system comprising:
a library to store a plurality of optical information media; and
a unit containing a read/write drive and a cassette for storing a plurality of optical information media,
wherein
the optical information media inside the cassette within the unit are carried to the read/write drive,
a plurality of units are installed in the library system, and
the library system includes a conveyance means between the library and the unit to convey the optical information media stored within the library to the cassette within the unit.

2. A library system according to claim 1, wherein the conveyance means carries one piece of optical information media.
